(19) United States
(12) Patent Application Publication
(10) Pub. No.: US 2024/0146644 A1
(43) Pub. Date: May 2, 2024

(54) ROUTING SELF-ORGANIZING NETWORKS USING APPLICATION QUALITY OF EXPERIENCE METRICS

(71) Applicant: Cisco Technology, Inc., San Jose, CA (US)

(72) Inventors: Jean-Philippe Vasseur, Saint Martin d’Uriage (FR); Grégory MERMOUD, Venthône (CH)

(21) Appl. No.: 17/974,718

(22) Filed: Oct. 27, 2022

(51) Int. Cl. H04L 45/302; H04L 43/08; H04L 43/16

(52) U.S. Cl. CPC H04L 45/302; H04L 43/08; H04L 43/16

(57) ABSTRACT

In one embodiment, a device receives quality of experience metrics from an online application. The device obtains physical link information from networking equipment in a network regarding physical interconnections between the networking equipment. The device selects, based on the quality of experience metrics, a set of next hops from among the physical interconnections between the networking equipment. The device causes traffic associated with the online application to be sent via a routing path that comprises the set of next hops.

### TECHNICAL FIELD

The present disclosure relates generally to computer networks, and, more particularly, to routing self-organizing networks using application quality of experience (QoE) metrics.

### BACKGROUND

Traditionally, routing traffic in a network has relied on the use of routing protocols that seek the ‘best’ path, or at least the next hop, to reach a destination. These routing protocols define the best path in terms of a distance vector or link states, according to a computed cost associated with each potential path. In its simplest form, the cost function may be computed as the number of hops along a path, with the path having the fewest number of hops as the best path. In more complex forms, the cost function may take into account Layer 3 metrics, such as loss, latency, or jitter, with the goal of finding the network path that minimizes any or all of these metrics.

With more and more applications moving to the cloud, a key assumption that simply ensuring that the path metrics of the selected routing path satisfy a service level agreement (SLA) associated with a given application will lead to a satisfactory user experience within the application has proven false. Indeed, testing has shown that what users of an application perceive and what is measured at the network level are not always aligned. This can be due to quite a number of different factors including the granularity at which the path metrics are probed, any resiliency to network conditions built into the application (e.g., due to the codec used), and the like.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example architecture for routing self-organizing networks using application quality of experience (QoE) metrics;

FIGS. 5A-5C illustrate examples of interconnected routers; and

FIG. 6 illustrates an example simplified procedure for routing self-organizing networks using application QoE metrics.

### DESCRIPTION OF EXAMPLE EMBODIMENTS

### Overview

According to one or more embodiments of the disclosure, a device receives quality of experience metrics from an online application. The device obtains physical link information from networking equipment in a network regarding physical interconnections between the networking equipment. The device selects, based on the quality of experience metrics, a set of next hops from among the physical interconnections between the networking equipment. The device causes traffic associated with the online application to be sent via a routing path that comprises the set of next hops.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

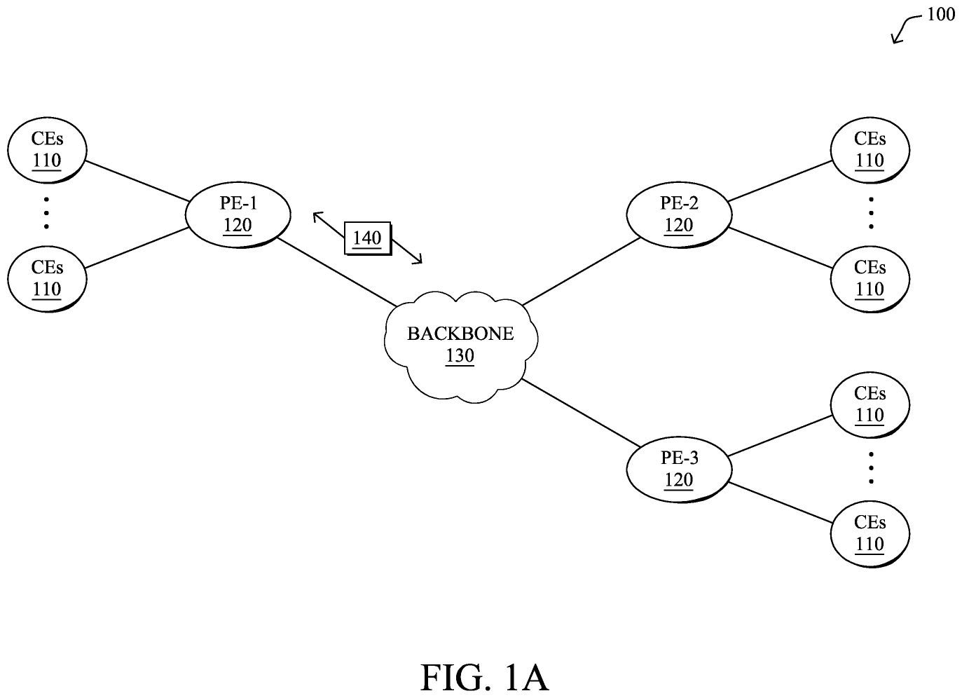

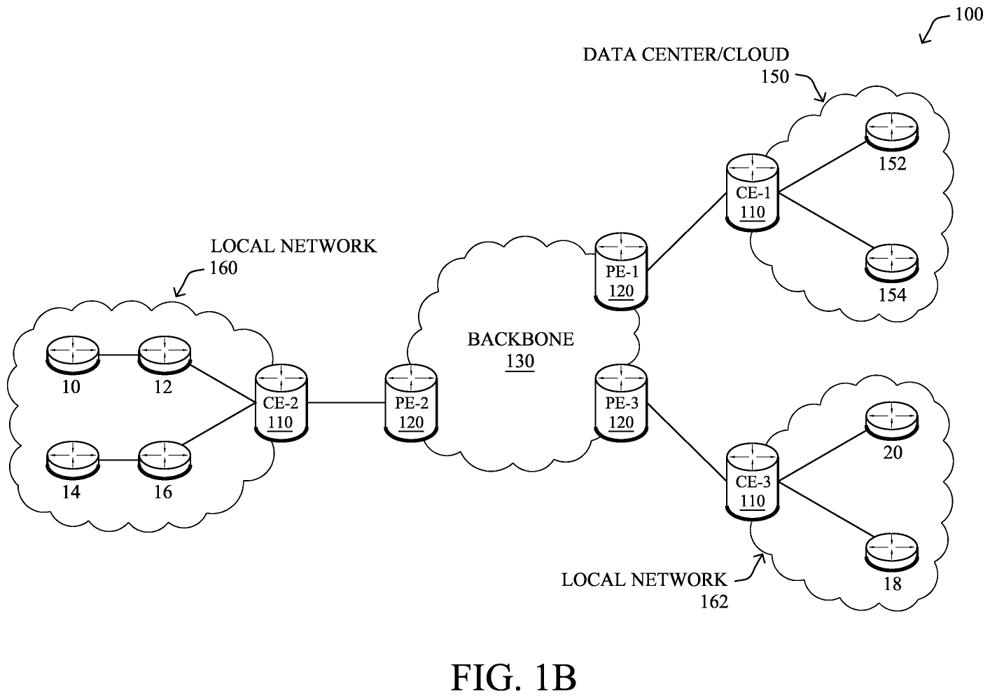

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2) Site Type B: a site connected to the network by the CE router via two primary links (e.g., from different Service Providers), with potentially a backup link (e.g., a 3G/4G/5G/LTE connection). A site of type B may itself be of different types:
2a) Site Type B1: a site connected to the network using two MPLS VPN links (e.g., from different Service Providers), with potentially a backup link (e.g., a 3G/4G/5G/LTE connection).
2b) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

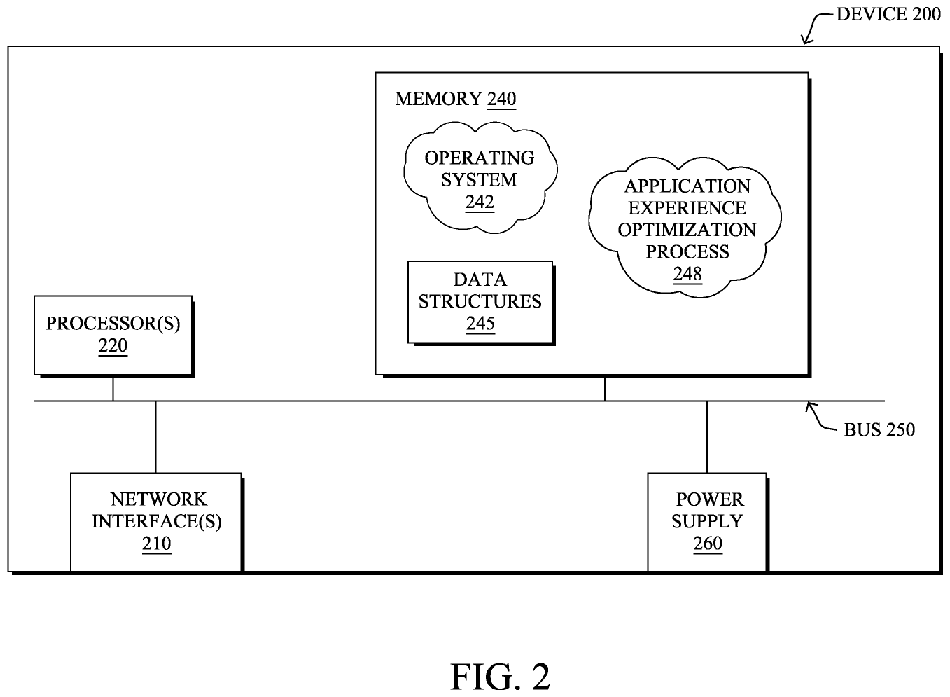

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an application experience optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, application experience optimization process 248 contains computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, process 248 may consist solely of providing mechanisms necessary for source routing techniques. That is, for source routing, other devices in the network can tell the less capable devices exactly where to send the packets, and the less capable devices simply forward the packets as directed.

In further embodiments, another potential routing protocol that process 248 may leverage is the Routing Protocol for Low-Power and Lossy Networks (RPL), which supports multipoint-to-point (MP2P) traffic from devices inside a Low-Power and Lossy Networks (LLNs) towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

A DAG is a directed graph having the property that all edges (and/or vertices) are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, in certain embodiments, a sibling of a node within a DAG may be defined as any neighboring node which is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or one preferred parent.

DAGs may generally be built (e.g., by a DAG process) based on an Objective Function (OF). The role of the Objective Function is generally to specify rules on how to build the DAG (e.g. number of parents, backup parents, etc.).

In addition, one or more metrics/constraints may be advertised by the routing protocol to optimize the DAG against. Also, the routing protocol allows for including an optional set of constraints to compute a constrained path, such as if a link or a node does not satisfy a required constraint, it is “pruned” from the candidate list when computing the best path. (Alternatively, the constraints and metrics may be separated from the OF.) Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc., are considered “DAG parameters.”

Illustratively, example metrics used to select paths (e.g., preferred parents) may comprise cost, delay, latency, bandwidth, expected transmission count (ETX), etc., while example constraints that may be placed on the route selection may comprise various reliability thresholds, restrictions on battery operation, multipath diversity, bandwidth requirements, transmission types (e.g., wired, wireless, etc.). The OF may provide rules defining the load balancing requirements, such as a number of selected parents (e.g., single parent trees or multi-parent DAGs).

Building a DAG may utilize a discovery mechanism to build a logical representation of the network, and route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going in the opposite direction to the upward messages within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (e.g., DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root that can in turn build the topology and locally compute downward routes to all nodes in the DODAG. Such nodes are then reachable using source routing techniques over regions of the DAG that are incapable of storing downward routing state. In addition, RPL also specifies a message called the DIS (DODAG Information Solicitation) message that is sent under specific circumstances so as to discover DAG neighbors and join a DAG or restore connectivity.

In various embodiments, as detailed further below, application experience optimization process 248 may further include computer executable instructions that, when executed by processor(s) 220, cause device 200 to perform the techniques described herein. To do so, in some embodiments, application experience optimization process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, application experience optimization process 248 and/or data denoising process may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that application experience optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

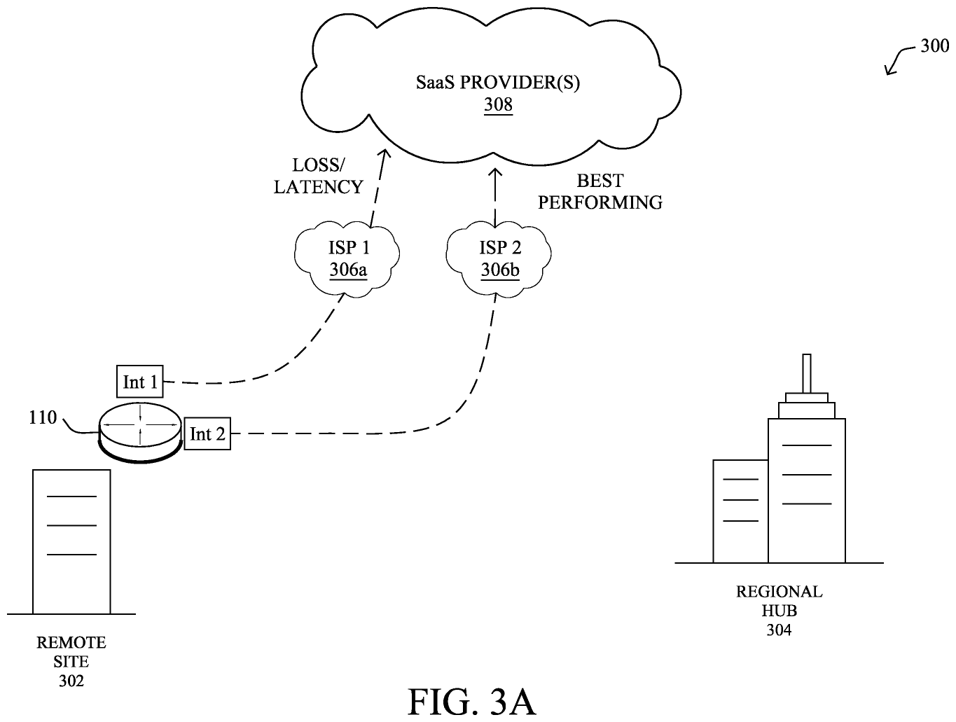

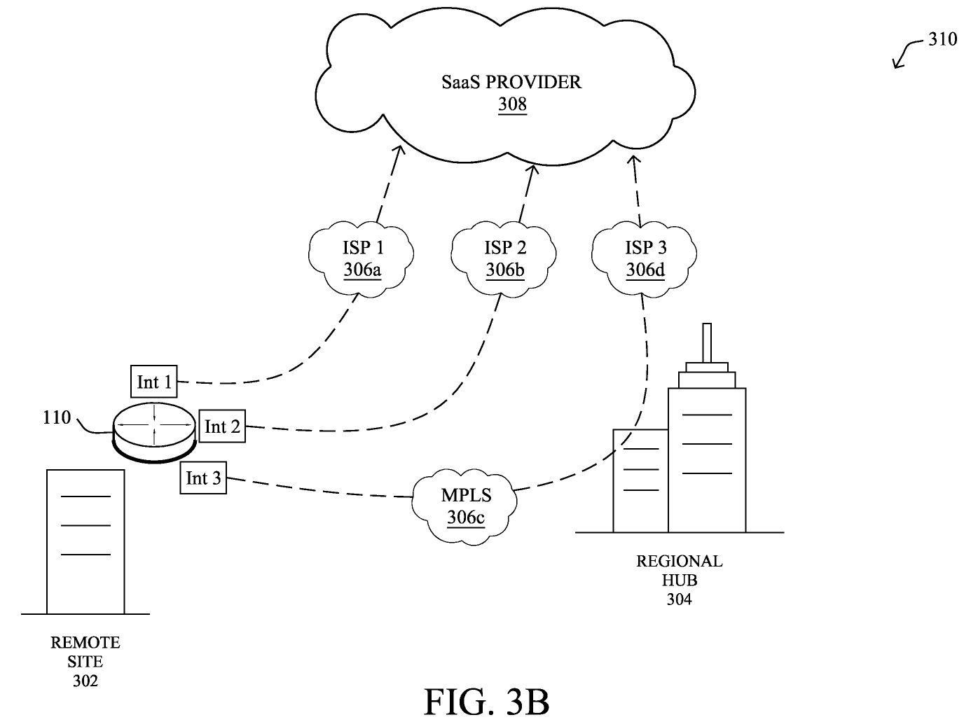

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, router 110 may provide connectivity to SaaS provider(s) 308 via tunnels across any number of networks 306. This allows clients located in the LAN of remote site 302 to access cloud applications (e.g., Office 365™ Dropbox™, etc.) served by SaaS provider(s) 308.

As would be appreciated, a variety of different pathways may exist between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

As noted above, routing traffic in a network has traditionally relied on routing protocols aiming at finding the ‘best’ path (or next hop) to reach a given destination. Typically, the best next hop is defined by a distance vector or link state routing protocols wherein the path cost is computed from any given node to a set of potential destinations. In its simplest form, such a path cost could be the number of visited hops (e.g., as done in the Routing Information Protocol (RIP)) or the sum of the costs of each traversed link along the path. Other protocols such as RPL use a distance vector approach by computing a DODAG from a DAG Root. With link state routing protocols, algorithms such as the Dijkstra algorithms have been used for shortest path computation where links could have one or more costs reflecting some link characteristics such as the delay, bandwidth, etc. Other approaches allow for adding constraints (thus pruning links not satisfying constraints) such as with MPLS Traffic Engineering (MPLS-TE).

Still, all existing routing approaches fundamentally rely on link and node layer characteristics used to compute a ‘shortest’ (constrained) path that may partially, often poorly, reflect the quality of service delivered to the application and the experience of the end user. More specifically, the subjective experience of a user of an online application and the performance metrics (e.g., loss, latency, jitter, etc.) of the network paths that convey the application traffic are often independent of one another. This can be due to a number of reasons such as, but not limited to, the granularity at which the path metrics are probed, any resiliency to network conditions built into the application (e.g., due to the codec used), and the like. Despite this, as noted, current routing approaches completely ignore the quality of experience (QoE) of the users of an online application.

### Routing Self-Organizing Networks Using Application OoE Metrics

The techniques herein introduce an approach to routing application traffic in a communication network by computing a topology that optimizes the overall application experience of all users for one or more applications. For the first time, the network topology is entirely driven by application QoE without considering link and/or node characteristics, but instead the QoE score of traffic flowing from a set of users to one or more servers hosting the application of interest for which the QoE must be optimized. In some aspects, such a QoE-optimized routing topology may be computed by a central agent in the network, thereby accounting for the intrinsic coupling of forwarding decisions of every individual device and optimizing for the global welfare of all users

Illustratively, the techniques described herein may be performed by hardware, software, and/or firmware, such as in application experience optimization process 248, which may include computer executable instructions executed by the processor 220 (or independent processor of interfaces 210) to perform functions relating to the techniques described herein.

Specifically, according to various embodiments, a device receives quality of experience metrics from an online application. The device obtains physical link information from networking equipment in a network regarding physical interconnections between the networking equipment. The device selects, based on the quality of experience metrics, a set of next hops from among the physical interconnections between the networking equipment. The device causes traffic associated with the online application to be sent via a routing path that comprises the set of next hops.

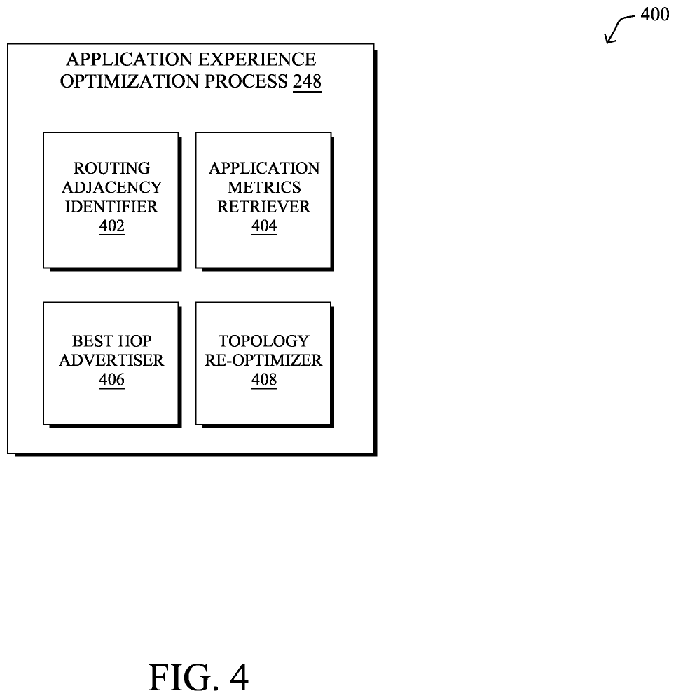

Operationally, FIG. 4 illustrates an example architecture for routing self-organizing networks using application QoE metrics, according to various embodiments. At the core of architecture 400 is application experience optimization process 248, which may be executed by a controller for a network, a networking device, or another device in communication therewith. For instance, application experience optimization process 248 may be executed by a path computation element (PCE) or other controller for a network, a particular networking device in the network (e.g., a router, etc.), another device or service in communication therewith, or the like.

As shown, application experience optimization process 248 may include any or all of the following components: a routing adjacency identifier 402, an application metrics retriever 404, a best hop advertiser 406, and/or a topology re-optimizer 408. As would be appreciated, the functionalities of these components may be combined or omitted, as desired (e.g., implemented as part of application experience optimization process 248).

In addition, these components may be implemented on a singular device or in a distributed manner, in which case the combination of executing devices can be viewed as their own singular device for purposes of executing application experience optimization process 248.

In various embodiments, routing adjacency identifier 402 may be used to retrieve, or otherwise obtain (e.g., on a pull or push basis), the local connectivity information for the networking equipment under consideration (e.g., the set of physical routing adjacencies of the routers in the network). To this end, each node may report its set of neighbors with which it shares physical, local links (e.g., optical, wireless, etc.) to routing adjacency identifier 402. Optionally, and potentially for purposes of backwards compatibility, the networking equipment/nodes may also report their cost metrics. As a result of this reporting, routing adjacency identifier 402 will now have information regarding the topology of the nodes. In some embodiments, existing routing protocols could be leveraged to discover the topology using a routing adjacency with any nodes when the routing protocol in use is a link state protocol. If the routing protocol in use is distance-based, then routing adjacency identifier 402 may poll each node and retrieve its set of neighbors using a novel signaling message.

According to various embodiments, application metrics retriever 404 may be responsible for obtaining application QoE metrics on a per-application basis from the SaaS/online application(s) of interest. To do so, application metrics retriever 404 may leverage application programming interfaces (APIs) of the applications to obtain QoE metrics for any number of hosts situated behind the different networking nodes under consideration.

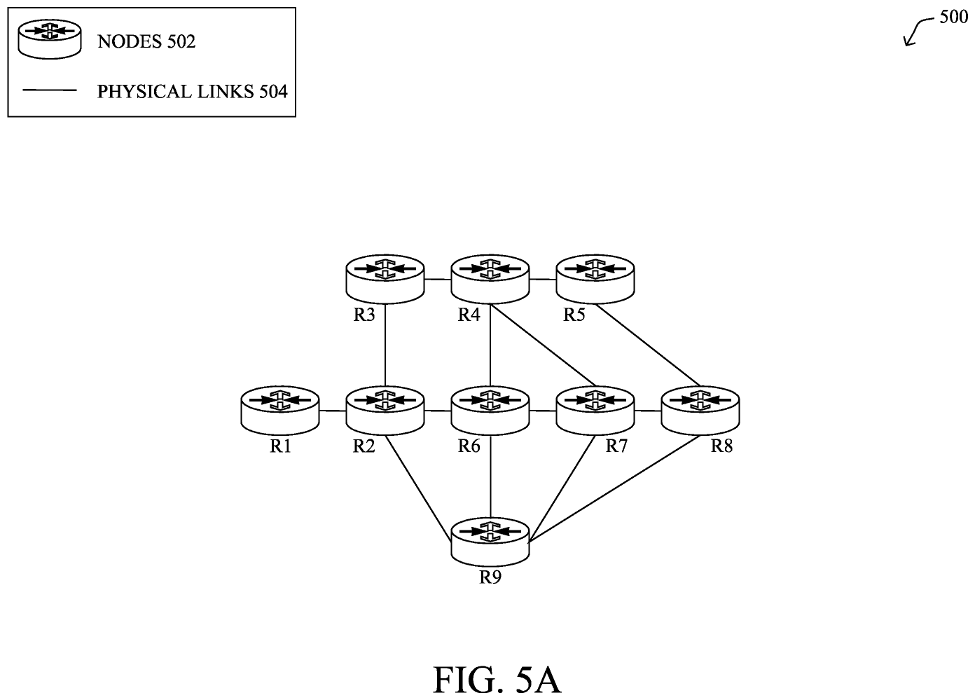

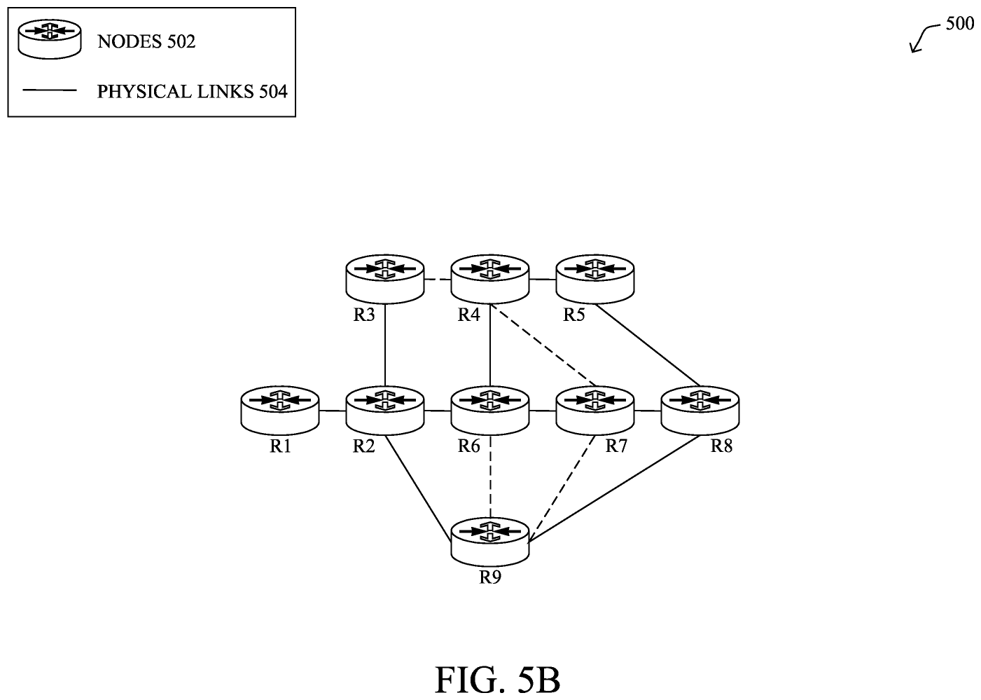

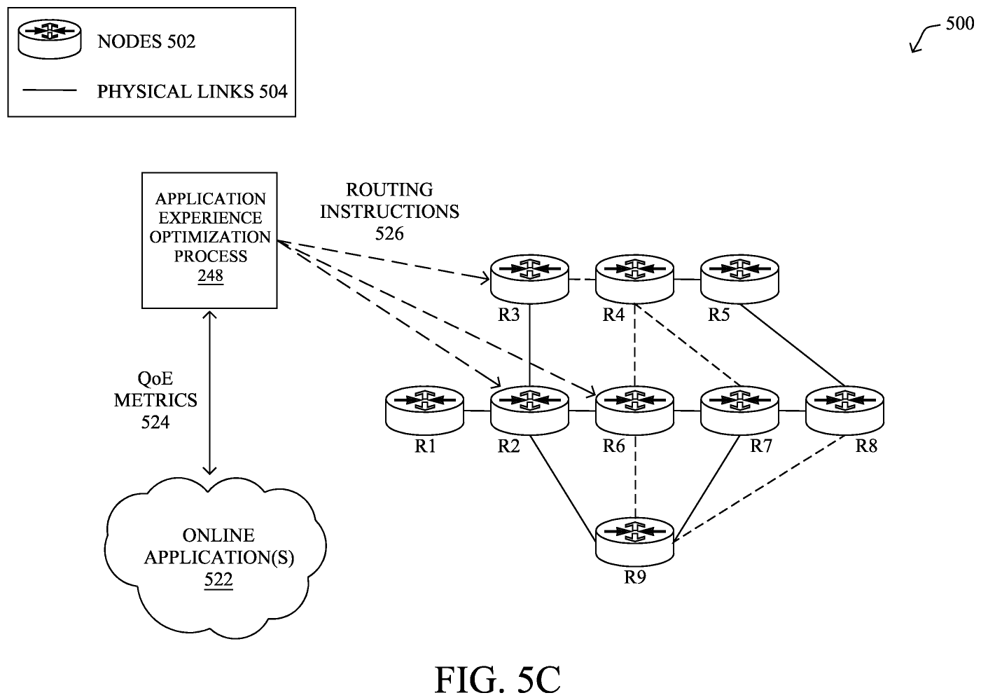

By way of example, consider network 500 shown in FIG. 5A comprising a plurality of nodes 502 interconnected by physical links 504, such as routers R1-R9 shown. In such a case, application metrics retriever 404 may retrieve QoE metrics for a particular application from any or all hosts/clients of the application connected to these routers.

In various embodiments, application metrics retriever 404 may use the link information obtained by routing adjacency identifier 402 regarding the physical interconnects (e.g., links 504), as well as the QoE metrics associated with the various application clients, to compute the best path for the application traffic. For example, such metrics may take the form of metrics based on satisfaction ratings that the users have provided (e.g., rating their experience on a scale of 0-5 stars, etc.), QoE metrics predicted or inferred from Layer-7 information within the application itself, or the like.

For example, consider the case of a videoconferencing application A1 hosted on one or more servers connected to R7. In such a case, let the QoE metric (A1,R1) denote the QoE of application A1 for the users connected to node R1. Such users may be identified by application metrics retriever 404 by matching their private/public IP address information with the local subnets connected to the node R7, in some cases. This process may be repeated for each node 502 having one or more clients of the application connected to it.

Note that the type of QoE metric, QoE(Ai, Rx), may be application-dependent. For example, for voice/video, the QoE metric may take the form of a Mean Opinion Score (MoS) to reflect the user experience (e.g., a scalar between 1-5). However, other QoE metrics may also be used, such as the percentage of time spent within bounds of a service level agreement (SLA), or even some custom score reflecting a given application experience. In other embodiments, the QoE may be obtained directly from the user by querying the users directly for satisfaction ratings.

Regardless, application metrics retriever 404 may inspect the network topology to select the set of best next hop(s) for the different nodes, taking into the observed QoE metrics for an application Ai.

As shown in FIG. 5B, consider again network 500 having nodes 502 interconnected by physical links 504. In the case of a link-state routing protocol being used, such as OSPF, each link state advertisement (LSA) will reflect the local connectivity of the nodes 502, thereby forming a link state database (LSDB). In contrast, using the techniques herein, application experience optimization process 248 may retrieve the local connectivity information, but not compute the shortest/best routing paths based on the link metrics. Instead, application experience optimization process 248 relies on the QoE metrics observed from each node 502 for any number of applications Ai. For example, in FIG. 5B, the link-state routing protocol may simply determine that the ‘best’ path between hosts connected to R1 and the application connected to R7 is R1-R2-R6-R7, by computing a shortest path tree for nodes 502.

However, in FIG. 5C, through the use of application experience optimization process 248 leveraging the QoE metrics 524 for the online application(s) 522, application experience optimization process 248 may instead determine that the optimal path for a given application is actually R1-R2-R9-R7. In turn, as detailed below, application experience optimization process 248 may send routing instructions 526 to nodes 502, notifying them of the selected next hops, so as to install the routing paths for the application traffic in network 500.

In some embodiments, the resulting routing topology created by application experience optimization process 248 may also be different for each application of interest.

Referring again to FIG. 4, best hop advertiser 406 may be configured to advertise the best next hop to each networking node supporting the techniques herein and for each application of interest Ai (e.g., by sending routing instructions 526 as in FIG. 5C). The ability for a node to support this functionality may be dynamically advertised using a router capability advertisement for both OSPF (e.g., using the Router Information Opaque LSA), ISIS router capabilities type-length-value (TLV), etc.

The set of applications of interest may also be dynamically discovered by each router using Deep Packet Inspection (DPI) and signaled to application experience optimization process 248 or configured according to policy.

Application experience optimization process 248 may also compute a set of best next hops (with local preference) to allow for traffic load balancing or selection of a next best hops should the local connectivity change and the best next hop no longer be available. In yet another embodiment, a local node may revert to its locally computed best next hop using a traditional routing approach (falling back to using Layer-3 metrics), should the techniques herein not be supported by the node (thus allowing for the deployment of mixed scenario) and should all best next hops become unavailable after a connectivity change in the network.

As would be appreciated, one of the main challenges relates to the interdependency of path selection across nodes, which justifies the need for the centralized path computation approach herein. In contrast with Layer-3 static metric used to compute shortest paths, traffic forwarding of a given node Ri does have an impact on the QoE of the traffic originated at a downstream node Rj. For example, if R2 in network 500 selects R9 for the application hosted behind R7, instead of selecting R3, additional traffic will be routed along the path R9-R7, possibly impacting the QoE of other applications or other users. In a network where core applications requiring strict SLA make use of per-queue application policy, the impact may be limited to one application whereas otherwise the extra traffic for application A may have an impact on other applications for the downstream nodes. Thus, a centralized QoE routing approach is required. In addition, the routing topologies should also be updated at a suitable frequency according to the observed per-application QoE.

In some embodiments, the general problem that application experience optimization process 248 must solve is essentially a reinforcement learning problem: application experience optimization process 248 ought to take actions in an environment (i.e., choosing one or more next hops for nodes in the network) to maximize a global cumulative reward (i.e., the QoE score of users of a given target application). In some embodiments, application experience optimization process 248 may do so by solving a multi-armed bandit problem with N-number of bandits that are networked with each other, so that pulling the ‘arm’ of one bandit influences the state of its neighboring bandits. In such a case, the question becomes which arms to pull and when, to maximize the cumulative reward. Regardless of the specific approach, there is coupling between decisions made by different agents on shared resources, or by a single agent on multiple, shared, resources.

Another applicable framework to solving the problem is actor-critic policy optimization in a partially observable multiagent environment. Indeed, application is experience optimization process 248 may prescribe the actions (i.e., choosing one or more next hops) of a set of agents (i.e., the nodes in the network) in an environment that is only partially observed (because paths along with no traffic is routed have an unknown QoE). In this context, the actor outputs the most optimal action for every agent and the critic evaluates these actions by predicting their value (i.e., the expected QoE for a given application). The key here is that the system must determine a so-called joint action a=[a1, a2, . . . , aN] for every node in the network, but each agent receives its own reward and observation. The advantage of this strategy over a purely global optimization (wherein the entire network is considered as a single agent) is that it is more easily amenable to a hybrid scenario wherein each agent may be constrained in different ways (e.g., due to local policies, lack of support of some options).

Indeed, a key feature of the proposed system is that it may account for a range of constraints that limit strictly the exploration behavior of the reinforcement learning agent(s). For instance, reachability (i.e., absence of loops or traffic blackholing) should be preserved across the exploration. Instead of a challenge, such constraints are useful insofar they reduce the size of the search space.

With respect to bootstrapping the system, prior to even performing any form of optimization, some reward may be collected on an initial state. To this end, classical routing could still be leveraged and the corresponding link metrics used to set up an initial routing topology, which can then be refined iteratively using any of the above strategies.

Finally, application experience optimization process 248 may also include topology re-optimizer 408, which is used to handle the global QoE topology re-optimization, in some embodiments. In various embodiments, topology re-optimizer 408 may do so based on a predefined trigger such as any or all of the following:
The percentage of application traffic with unacceptable QoE metrics or SLA violations exceeds a threshold, for one or more applications.
Routing topology changes reported by the nodes in the network.
Drastic changes of the traffic matrix (as reported by a network management system, software defined networking controller, or obtained by polling the network nodes).

When updating the QoE topology, local loops may take place until all nodes have applied the new routing policy. To that end, topology re-optimizer 408 may apply changes to the QoE-based routing topology according to a schedule, which may require the nodes to have synchronized clocks.

It should also be noted that the techniques herein operate on the routing topology between the physical networking equipment themselves, in contrast to software defined wide area network (SD-WAN) solutions where the decision relates to the selection of the best path from an edge device. Instead, the techniques herein can be used to build QoE topologies for routing within a routing domain such as IP networks or even an IoT (Internet Of Things) routing mesh, or even an underlay of an SDN/SD-WAN.

In summary, a new routing paradigm is introduced herein whereby instead of computing shortest paths using (static) Layer-3 metrics reflecting link characteristics, a central engine/agent may perform any or all of the following: 1) retrieves the physical network topologies from a plurality of nodes in the communication network, 2) gathers per-application QoE for a set of applications of interest hosted in a private cloud or public SaaS from host locally connected to the set of nodes, 3) computes the best hop from each node that provides the most optimized QoE among a set of nodes form the topologies, 4) provides the set of next hops to each nodes supporting the proposed invention thus build a routing strategy hop-by-hop within a routing domain entirely optimized for application QoE.

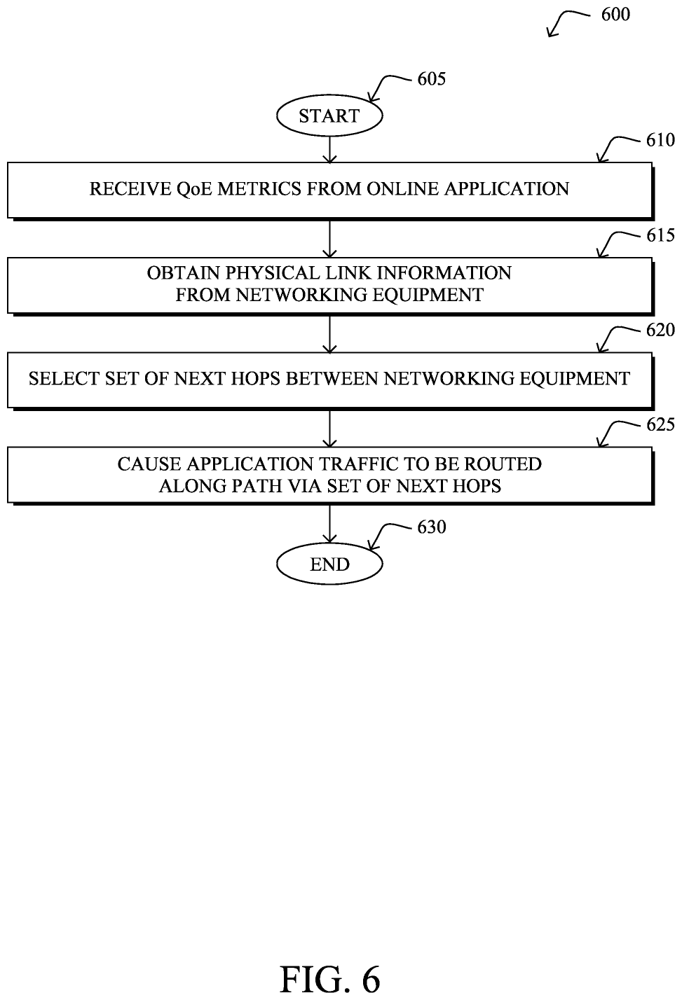

FIG. 6 illustrates an example simplified procedure 600 (e.g., a method) for routing self-organizing networks using application QoE metrics, in accordance with one or more embodiments described herein. For example, a non-generic, specifically configured device (e.g., device 200), such as controller for a network (e.g., an SDN controller, a cloud-based device, etc.), an edge router, or other device in communication therewith, may perform procedure 600 by executing stored instructions (e.g., application experience optimization process 248). The procedure 600 may start at step 605, and continues to step 610, where, as described in greater detail above, the device may receive QoE metrics from an online application. In some embodiments, the QoE metrics are indicative of satisfaction ratings provided by users of the online application. In further embodiments, the device receives the QoE metrics from the online application via an application programming interface (API) of the online application.

At step 615, as detailed above, the device may obtain physical link information from networking equipment in a network regarding physical interconnections between the networking equipment. In some embodiments, the networking equipment comprises a plurality of routers.

At step 620, the device may select, based on the QoE metrics, a set of next hops from among the physical interconnections between the networking equipment, as described in greater detail above. In some embodiments, the device selects the set of next hops by using reinforcement learning with a reward function that seeks to maximize the quality of experience metrics from the online application.

At step 625, as detailed above, the device may cause traffic associated with the online application to be sent via a routing path that comprises the set of next hops. In some embodiments, the routing path is configured in an underlay of a software-defined network (SDN). In one embodiment, the device may also compute an updated routing path for the traffic associated with the online application, in response to a detected trigger. In one embodiment, the detected trigger indicates a threshold percentage of traffic in the network having unacceptable QoE metrics. In another embodiment, the detected trigger indicates a change in a traffic matrix. In a further embodiment, the detected trigger indicates a routing topology change reported by a particular one of the networking equipment.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for routing self-organizing networks using application QoE metrics, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
receiving, at a device, quality of experience metrics from an online application;
obtaining, by the device, physical link information from networking equipment in a network regarding physical interconnections between the networking equipment;
selecting, by the device and based on the quality of experience metrics, a set of next hops from among the physical interconnections between the networking equipment; and
causing, by the device, traffic associated with the online application to be sent via a routing path that comprises the set of next hops.

2. The method as in claim 1, wherein the quality of experience metrics are indicative of satisfaction ratings provided by users of the online application.

3. The method as in claim 1, wherein the device receives the quality of experience metrics from the online application via an application programming interface (API) of the online application.

4. The method as in claim 1, wherein the device selects the set of next hops by using reinforcement learning with a reward function that seeks to maximize the quality of experience metrics from the online application.

5. The method as in claim 1, further comprising:
computing an updated routing path for the traffic associated with the online application, in response to a detected trigger.

6. The method as in claim 5, wherein the detected trigger indicates a threshold percentage of traffic in the network having unacceptable quality of experience metrics.

7. The method as in claim 5, wherein the detected trigger indicates a change in a traffic matrix.

8. The method as in claim 5, wherein the detected trigger indicates a routing topology change reported by a particular one of the networking equipment.

9. The method as in claim 1, wherein the routing path is configured in an underlay of a software-defined network (SDN).

10. The method as in claim 1, wherein the networking equipment comprises a plurality of routers.

11. An apparatus, comprising:
one or more network interfaces;
a processor coupled to the one or more network interfaces and configured to execute one or more processes; and
a memory configured to store a process that is executable by the processor, the process when executed configured to:
receive quality of experience metrics from an online application;
obtain physical link information from networking equipment in a network regarding physical interconnections between the networking equipment;
select, based on the quality of experience metrics, a set of next hops from among the physical interconnections between the networking equipment; and
cause traffic associated with the online application to be sent via a routing path that comprises the set of next hops.

12. The apparatus as in claim 11, wherein the quality of experience metrics are indicative of satisfaction ratings provided by users of the online application.

13. The apparatus as in claim 11, wherein the apparatus receives the quality of experience metrics from the online application via an application programming interface (API) of the online application.

14. The apparatus as in claim 11, wherein the apparatus selects the set of next hops by using reinforcement learning with a reward function that seeks to maximize the quality of experience metrics from the online application.

15. The apparatus as in claim 11, wherein the process when executed is further configured to:
compute an updated routing path for the traffic associated with the online application, in response to a detected trigger.

16. The apparatus as in claim 15, wherein the detected trigger indicates a threshold percentage of traffic in the network having unacceptable quality of experience metrics.

17. The apparatus as in claim 15, wherein the detected trigger indicates a change in a traffic matrix.

18. The apparatus as in claim 15, wherein the detected trigger indicates a routing topology change reported by a particular one of the networking equipment.

19. The apparatus as in claim 11, wherein the routing path is configured in an underlay of a software-defined network (SDN).

20. A tangible, non-transitory, computer-readable medium storing program instructions that cause a device to execute a process comprising:
receiving, at the device, quality of experience metrics from an online application;
obtaining, by the device, physical link information from networking equipment in a network regarding physical interconnections between the networking equipment;
selecting, by the device and based on the quality of experience metrics, a set of next hops from among the physical interconnections between the networking equipment; and
causing, by the device, traffic associated with the online application to be sent via a routing path that comprises the set of next hops.
